(19) United States
(12) Patent Application Publication
(10) Pub. No.: US 2004/0131138 A1
(43) Pub. Date: Jul. 8, 2004

(54) Brayton cycle nuclear power plant and a method of starting the brayton cycle

(76) Inventors: Michael Correia, Moreleta Park (ZA); Adriaan Odendaal Kriel, Centurion (ZA)

Correspondence Address: David A Cherry, Woodcock Washburn, 46th Floor, One Liberty Place, Philadelphia, PA, 19103, US

(21) Appl. No.: 10/478,610

(22) PCT Filed: May 22, 2002
(86) PCT No.: PCT/IB02/01754

(30) Foreign Application Priority Data
May 25, 2001 (ZA) 2001/4319

(51) Int. Cl. G21C 15/00; G21C 19/28

(52) U.S. Cl. 376/381

(57) ABSTRACT

A nuclear plant includes a closed loop power generation circuit which makes use of a Brayton cycle as a thermodynamic conversion cycle. The plant further includes a start-up blower system having an in-line valve and a blower connected in parallel with the in-line valve. Further a normally closed blower isolation valve is provided in series with the blower and a blower bypass arrangement in parallel with the blower. A method of starting the Brayton cycle includes bringing the power generation circuit into standby mode in which helium is circulated around the power generation circuit by the start-up blower system and increasing power generated in the power generation circuit until the helium is circulated around the power generation circuit by a compressor independently of the start-up blower system.

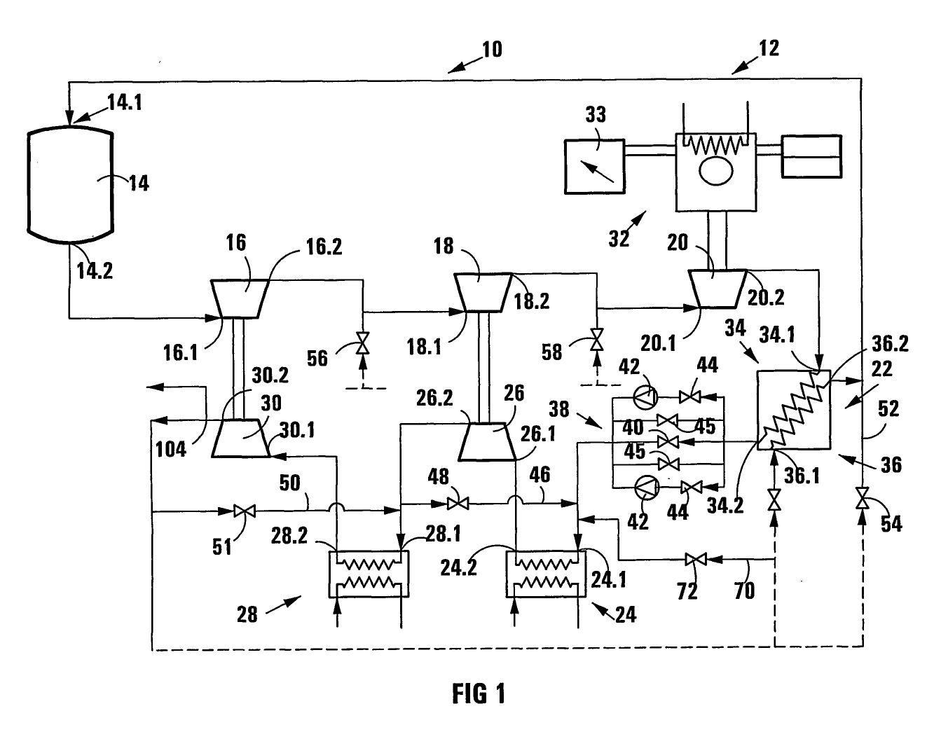

THIS INVENTION relates to a nuclear power plant. More particularly it relates to a nuclear power plant making use of a Brayton cycle as the thermodynamic conversion cycle, and to a method of starting the Brayton cycle.

In a nuclear power plant which includes a closed loop power generation circuit configured to make use of a Brayton cycle as the thermodynamic conversion cycle, one problem that is experienced is that the Brayton cycle is not self-starting from zero mass flow.

According to one aspect of the invention in a nuclear power plant making use of helium as the working fluid and having a closed loop power generation circuit which is intended to make use of a Brayton cycle as the thermodynamic conversion cycle and which includes a nuclear reactor having an inlet and an outlet, a turbine arrangement, an upstream side of which is connected to the outlet of the reactor, at least one compressor to which the turbine arrangement is drivingly connected and at least one heat exchanger, there is provided a method of starting the Brayton cycle which includes the steps of

if not already in standby mode, bringing the power generation circuit into standby mode in which helium is circulated around the power generation circuit by a start-up blower system; and

increasing power generated in the power generation circuit until the at least one compressor is capable of circulating helium around the power generation circuit without the assistance of the start-up blower system.

When the plant includes a generator and the turbine arrangement includes a power turbine drivingly connected to the generator, the method may include the steps of

applying a load to the power turbine and regulating the speed of the power turbine at a speed below the normal operational speed of the power turbine;

decreasing the applied load to permit the speed of the power turbine to increase to the normal operational speed of the power turbine;

synchronizing the generator output to an electrical distribution grid; and

increasing the power output of the power turbine while the generator output remains synchronized with the grid.

Applying a load to the power turbine may be via a variable resistor bank connected to the generator.

Decreasing the applied load may be achieved by decreasing the resistance of the resistor bank.

The method may include, after the generator output has been synchronized to the electrical distribution grid and the power generation circuit has been stabilized, disconnecting the variable resistor bank from the generator.

Decreasing the applied load may include decreasing the load from about 1 MW to about 300 KW.

The method may include regulating the speed of the power turbine to a speed which is between 55 and 65% of normal operating speed.

When the normal operating speed of the power turbine is 3000 rpm, the method may include regulating the speed of the power turbine to about 1800 rpm.

When the power generation circuit includes a low pressure compressor and a high pressure compressor and the turbine arrangement includes a low pressure turbine and a high pressure turbine which are drivingly connected to the low pressure compressor and the high pressure compressor, respectively, and the power generation circuit includes a low pressure recirculation line in which a low pressure recirculation valve is mounted and a high pressure recirculation line in which a high pressure recirculation valve is mounted, the low pressure and high pressure recirculation lines extending from positions downstream to positions upstream of the low and high pressure compressors, respectively, the method may include stabilizing the power generation circuit using at least one of the low pressure and high pressure recirculation valves.

When the power generation circuit includes a recuperator, having a high pressure side and a low pressure side, a recuperator bypass line extending from a position upstream to a position downstream of the high pressure side of the recuperator and a recuperator bypass valve mounted in the recuperator bypass line to regulate the flow of helium therethrough, increasing the power generated by the power generation circuit may include displacing at least one of the recirculation valves and the bypass valve from an open position towards a closed position. The closure of the valves results in a substantial increase in the efficiency of the Brayton cycle.

Once started, the Brayton cycle is self-sustaining and the circulation of helium in the power generation circuit is effected by the compressors.

The method may include, when the Brayton cycle becomes self sustaining, shutting down the start-up blower system. One measure which can be used to determine when the Brayton cycle becomes self-sustaining is when the pressure difference across the start-up blower system decreases below a predetermined pressure difference, typically 20 kPa.

The start-up blower system may include, in parallel, at least one blower and a start-up blower system in-line valve and connected in series with the blower a blower isolation valve. In stand-by mode, the power generation circuit is configured such that the start-up blower in-line valve is closed, the or each blower isolation valve is opened and the or each blower is operational. The blowers then cause the circulation of helium in the power generation circuit. Shutting down the start-up blower system may include opening the start-up blower system in-line valve, discontinuing operation of the blower and closing the blower isolation valve.

According to another aspect of the invention there is provided a nuclear power plant which includes

a closed loop power generation circuit; and

a start-up blower system which includes

a normally open in-line valve;

at least one blower connected in parallel with the in-line valve;

a normally closed blower isolation valve in series with the or each blower; and

a blower bypass arrangement in parallel with the or each blower.

The closed loop power generation circuit may include a nuclear reactor having an inlet and an outlet, a turbine arrangement, an upstream side of which is connected to the outlet of the reactor, a recuperator having a low pressure side and a high pressure side, each side of the recuperator having an inlet and an outlet, at least one compressor to which the turbine arrangement is drivingly connected and at least one heat exchanger, the closed loop power generation circuit being arranged to make use of a Brayton cycle as the thermodynamic conversion cycle, the plant further including a generator to which the turbine arrangement is drivingly connected and a variable resistor bank which is disconnectably connectable to the generator.

The power generation circuit may include a high pressure compressor and a low pressure compressor, the turbine arrangement including a high pressure turbine drivingly connected to the high pressure compressor, a low pressure turbine drivingly connected to the low pressure compressor and a power turbine drivingly connected to the generator.

The power generation circuit may include a pre-cooler connected between an outlet of the low pressure side of the recuperator and an inlet of the low pressure compressor and an inter-cooler connected between an outlet of the low pressure compressor and an inlet of the high pressure compressor.

The start-up blower system may be positioned between the low pressure side of the recuperator and the pre-cooler.

The power generation circuit may include a low pressure compressor recirculation line in which a low pressure recirculation valve is mounted, the low pressure recirculation line extending from a position between the downstream side of the low pressure compressor and the inlet of the inter-cooler to a position between the start-up blower system and the inlet of the pre-cooler.

The power generation circuit may include a high pressure compressor recirculation line in which a high pressure compressor recirculation valve is mounted, the line extending from a position between the downstream side of the high pressure compressor and the inlet of the high pressure side of the recuperator to a position between the outlet of the low pressure compressor and the inlet of the intercooler.

The power generation circuit may include a recuperator bypass line in which a recuperator bypass valve is mounted, the recuperator bypass line extending from a position upstream of the inlet of the high pressure side of the recuperator to a position downstream of the outlet of the high pressure side of the recuperator.

The power generation circuit may further include a high pressure coolant valve and a low pressure coolant valve, the high pressure coolant valve being configured, when open, to provide a bypass of helium from the high pressure side of the high pressure compressor to the inlet of the low pressure turbine and the low pressure coolant valve being configured to provide a bypass of helium from the high pressure side of the high pressure compressor to the inlet of the power turbine.

The reactor may be of the pebble bed type making use of spherical fuel elements.

The start-up blower system may include two blowers which are connected in parallel with a start-up blower in-line valve and a blower isolation valve which is associated with each blower.

The blower bypass valves are used to avoid surge of the blowers.

In the stand-by mode the recuperator bypass valve is operated to maintain the reactor inlet temperature at a level such that the outlet temperature of the start-up blower system is below a predetermined temperature, typically 250° C. The high pressure coolant valve and low pressure coolant valve are operated to ensure that the maximum temperature in the recuperator is maintained below a predetermined temperature, typically 600° C. The high pressure compressor recirculation valve and low pressure compressor recirculation valve are operated to regulate the power generated in the power turbine.

Further, the reactor outlet temperature is regulated to a temperature of between 750° C. and 900° C. The pre-cooler and the inter-cooler ensure that helium entering the low pressure and high pressure compressors is at a temperature of approximately 30° C. The pressure of helium within the power generation circuit is maintained at a pressure of between 20 and 50 bar.

The invention will now be described, by way of example, with reference to the accompanying diagrammatic drawing which shows a schematic representation of a nuclear power plant in accordance with the invention.

In the drawing, reference numeral 10 refers generally to part of a nuclear power plant in accordance with the invention.

The nuclear power plant 10 includes a closed loop power generation circuit, generally indicated by reference numeral 12. The power generation circuit 12 includes a nuclear reactor 14, a high pressure turbine 16, a low pressure turbine 18, a power turbine 20, a recuperator 22, a pre-cooler 24, a low pressure compressor 26, an intercooler 28 and a high pressure compressor 30.

The reactor 14 is a pebble bed reactor making use of spherical fuel elements. The reactor 14 has an inlet 14.1 through which working fluid in the form of helium can be introduced into the reactor 14 and an outlet 14.2.

The high pressure turbine 16 is drivingly connected to the high pressure compressor 30 and has an upstream side or inlet 16.1 and a downstream side or outlet 16.2, the inlet 16.1 being connected to the outlet 14.2 of the reactor 14.

The low pressure turbine 18 is drivingly connected to the low pressure compressor 26 and has an upstream side or inlet 18.1 and a downstream side or outlet 18.2. The inlet 18.1 is connected to the outlet 16.2 of the high pressure turbine 16.

The power turbine 20 is drivingly connected to a generator 32. The power turbine 20 includes an upstream side or inlet 20.1 and a downstream side or outlet 20.2. The inlet 20.1 of the power turbine 20 is connected to the outlet 18.2 of the low pressure turbine 18.

The plant further includes a variable resistor bank 33 which is disconnectably connectable to the generator 32.

The recuperator 22 has a hot or low pressure side 34 and a cold or high pressure side 36. The low pressure side of the recuperator 34 has an inlet 34.1 and an outlet 34.2. The inlet 34.1 of the low pressure side is connected to the outlet 20.2 of the power turbine 20.

The pre-cooler 24 is a helium to water heat exchanger and includes a helium inlet 24.1 and a helium outlet 24.2. The inlet 24.1 of the pre-cooler 24 is connected to the outlet 34.2 of the low pressure side 34 of the recuperator 22.

The low pressure compressor 26 has an upstream side or inlet 26.1 and a downstream side or outlet 26.2. The inlet 26.1 of the low pressure compressor 26 is connected to the helium outlet 24.2 of the pre-cooler 24.

The inter-cooler 28 is a helium to water heat exchanger and includes a helium inlet 28.1 and a helium outlet 28.2. The helium inlet 28.1 is connected to the outlet 26.2 of the low pressure compressor 26.

The high pressure compressor 30 includes an upstream side or inlet 30.1 and a downstream side or outlet 30.2. The inlet 30.1 of the high pressure compressor 30 is connected to the helium outlet 28.2 of the inter-cooler 28. The outlet 30.2 of the high pressure compressor 30 is connected to an inlet 36.1 of the high pressure side of the recuperator 22. An outlet 36.2 of the high pressure side of the recuperator 22 is connected to the inlet 14.1 of the reactor 14.

The nuclear power plant 10 includes a start-up blower system, generally indicated by reference numeral 38, connected between the outlet 34.2 of the low pressure side 34 of the recuperator 22 and the inlet 24.1 of the pre-cooler 24.

The start-up blower system 38 includes a normally open start-up blower system in-line valve 40 which is connected in line between the outlet 34.2 of the low pressure side of the recuperator and the inlet 24.1 of the pre-cooler 24. Two blowers 42 are connected in parallel with the start-up blower system in-line valve 40 and a normally closed isolation valve 44 is associated with and connected in series with each blower 42. In addition, a blower bypass valve arrangement 45 is associated with and connected in parallel with each of the blowers 44. Each blower bypass valve arrangement 45 may comprise one or more bypass valves which can be independently controlled. It will be appreciated that the blower bypass valve arrangement 45 could consist of a single valve which serves both blowers.

A low pressure compressor recirculation line 46 extends from a position between the outlet or downstream side 26.2 of the low pressure compressor 26 and the inlet 28.1 of the inter-cooler 28 to a position between the start-up blower system 38 and the inlet 24.1 of the pre-cooler 24. A normally closed low pressure recirculation valve 48 is mounted in the low pressure compressor recirculation line 46.

A high pressure compressor recirculation line 50 extends from a position between the outlet or downstream side 30.2 of the high pressure compressor and the inlet 36.1 of the high pressure side 36 of the recuperator 22 to a position between the outlet or downstream side 26.2 of the low pressure compressor 26 and the inlet 28.1 of the intercooler 28. A normally closed high pressure recirculation valve 51 is mounted in the high pressure compressor recirculation line 50.

A recuperator bypass line 52 extends from a position upstream of the inlet 36.1 of the high pressure side 36 of the recuperator 22 to a position downstream of the outlet 36.2 of the high pressure side 36 of the recuperator 22. A normally closed recuperator bypass valve 54 is mounted in the recuperator bypass line 52.

The plant 10 includes a high pressure coolant valve 56 and a low pressure coolant valve 58. The high pressure coolant valve 56 is configured, when open, to provide a bypass of helium from the high pressure side or outlet 30.2 of the high pressure compressor 30 to the inlet or low pressure side 18.1 of the low pressure turbine 18. The low pressure coolant valve 58 is configured, when open, to provide a bypass of helium from the high pressure side or outlet 30.2 of the high pressure compressor 30 to the inlet 20.1 of the power turbine 20.

The power generation circuit 12 is configured to operate on a Brayton cycle as the thermodynamic conversion cycle. When the Brayton cycle is operational, the circulation flow in the power generation circuit is provided by the compressors 26, 30.

In use, in order to start the Brayton cycle, mass flow around the power generation circuit is achieved by means of the start-up blower system 38. More particularly, the start-up blower system in-line valve 40 is closed, the isolation valves 44 are opened and the blowers 42 are operated. While the blowers 42 are operating, the blower bypass valve arrangements 45 are used to avoid surge of the blowers 42.

Prior to initiating the procedure to start-up the Brayton cycle, the power generation circuit if not already in standby mode is brought into standby mode. The main characteristics of the standby mode are that the blowers 42 are operational.

In order to reduce the risk of damage to the blowers 42 it is important that the maximum temperature in the blowers be maintained below a predetermined maximum temperature, typically 250° C. In this regard, the recuperator bypass valve 54 is operated which controls the core inlet temperature and so indirectly the maximum temperature in the start-up blower system 38. In addition, as mentioned above, the blower bypass valve arrangements 45 are used to avoid surge of the blowers 44 and thereby minimize the risk of damage thereto.

Further, in order to regulate the maximum temperature in the recuperator 22, one or both of the high pressure coolant recirculation valve 56 and low pressure coolant recirculation valve 58 are operated in order to ensure that the maximum temperature in the recuperator remains below a predetermined maximum temperature, typically 600° C.

Further, the power generated in the power turbine is controlled, typically by operation of the high pressure recirculation valve 51 and/or low pressure recirculation valve 48, so that the power does not exceed a predetermined level, e.g. 1 MW and the speed of the power turbine 20 is regulated, by a speed controller, at a speed below the normal operational speed, i.e. typically at 30 Hz.

The outlet temperature of the reactor 14 is regulated by a reactor outlet temperature controller at a temperature of between 750° C. and 900° C.

The pre-cooler 24 and inter-cooler 28 function in their normal operation mode, ensuring that the inlet temperature of the low pressure compressor 26 and high pressure compressor 30 are at approximately 30° C.

Further, the pressure level in the power generation circuit is between 20 bar and 50 bar.

In order to start-up the Brayton cycle, with the plant in its standby mode as described above, with the high pressure recirculation valve and low pressure recirculation valve controlling the power generated by the generator, the variable resistor bank 33 is connected to the generator 32. The speed controller controls the turbine speed at a speed below the normal operation speed of the turbine, i.e. about 30 Hz.

When this condition is stabilized, the power of the variable resistor bank 33 is decreased from approximately 1 MW to approximately 300 kW. This decrease in power results in an increase in the speed of the turbine 20 and hence the generator 32. When the turbine 20 reaches the desired operational speed, typically 50 Hz, the power of the variable resistor bank is once again increased to the predetermined level, typically 1 MW, and the speed of the turbine is controlled at 50 Hz by means of the speed controller.

After the situation is stabilized, the procedure to synchronize the generator output to the grid is executed.

A short time, typically about 10 minutes, after the system is synchronized to the grid and stabilized, the speed controller is turned off, i.e. the variable resistor bank is disconnected from the generator 32 and the recirculation valves start to close. More particularly, the low pressure recirculation valve 48 and high pressure recirculation valve 51 along with the recuperator bypass valve 54 are closed. During this process, the output of the power turbine 20 increases as the performance of the Brayton cycle improves significantly by closing the recirculation valves 48, 51.

During one of the described procedural steps, dependent on the pressure and temperature level in the system, the Brayton cycle will start and take over the compressor function of the start-up blower system 38.

Typically, when the pressure difference (outlet pressure minus inlet pressure) across the start-up blower system decreases below a predetermined level, typically 20 kPa, the compressor function of the Brayton cycle is self-sustaining. After the Brayton cycle is self-sustaining, the start-up blower system will be shut down.

An important characteristic of the described process is that the actual start-up of the Brayton cycle may take place at any moment during the execution of the above-described procedures. It does not affect the execution of the other process steps and the system behaviour is also not really affected.

1. In a nuclear power plant making use of helium as the working fluid and having a closed loop power generation circuit which is intended to make use of a Brayton cycle as the thermodynamic conversion cycle and which includes a nuclear reactor having an inlet and an outlet, a turbine arrangement, an upstream side of which is connected to the outlet of the reactor, at least one compressor to which the turbine arrangement is drivingly connected and at least one heat exchanger, there is provided a method of starting the Brayton cycle which includes the steps of
if not already in standby mode, bringing the power generation circuit into standby mode in which helium is circulated around the power generation circuit by a start-up blower system; and
increasing power generated in the power generation circuit until the at least one compressor is capable of circulating helium around the power generation circuit without the assistance of the start-up blower system.

2. A method as claimed in claim 1, which, when the plant includes a generator and the turbine arrangement includes a power turbine drivingly connected to the generator, includes the steps of
applying a load to the power turbine and regulating the speed of the power turbine at a speed below the normal operational speed of the power turbine;
decreasing the applied load to permit the speed of the power turbine to increase to the normal operational speed of the power turbine;
synchronizing the generator output to an electrical distribution grid; and
increasing the power output of the power turbine while the generator output remains synchronized with the grid.

3. A method as claimed in claim 2, in which applying a load to the power turbine is via a variable resistor bank connected to the generator.

4. A method as claimed in claim 3, in which decreasing the applied load is achieved by decreasing the resistance of the resistor bank.

5. A method as claimed in claim 3 or claim 4, which includes, after the generator output has been synchronized to the electrical distribution grid and the power generation circuit has been stabilized, disconnecting the variable resistor bank from the generator.

6. A method as claimed in any one of claims 2 to 4, inclusive, in which decreasing the applied load includes decreasing the load from about 1 MW to about 300 KW.

7. A method as claimed in any one of claims 2 to 6, inclusive, which includes regulating the speed of the power turbine to a speed of between 55 and 65% of normal operating speed.

8. A method as claimed in any one of claims 2 to 7, inclusive, in which when the normal operating speed of the power turbine is 3000 rpm, includes regulating the speed of the power turbine to about 1800 rpm.

9. A method as claimed in any one of claims 2 to 8, which, when the power generation circuit includes a low pressure compressor and a high pressure compressor and the turbine arrangement includes a low pressure turbine and a high pressure turbine which are drivingly connected to the low pressure compressor and the high pressure compressor, respectively, and the power generation circuit includes a low pressure recirculation line in which a low pressure recirculation valve is mounted and a high pressure recirculation line in which a high pressure recirculation valve is mounted, the low pressure and high pressure recirculation lines extending from positions downstream to positions upstream of the low and high pressure compressors, respectively, includes stabilizing the power generation circuit using at least one of the low pressure and high pressure recirculation valves.

10. A method as claimed in claim 9, in which, when the power generation circuit includes a recuperator, having a high pressure side and a low pressure side, a recuperator bypass line extending from a position upstream to a position downstream of the high pressure side of the recuperator and a recuperator bypass valve mounted in the recuperator bypass line to regulate the flow of helium therethrough, increasing the power generated by the power generation circuit includes displacing at least one of the recirculation valves and the bypass valve from an open position towards a closed position.

11. A method as claimed in any one of claims 2 to 10, inclusive, which includes, when the Brayton cycle becomes self sustaining, shutting down the start-up blower system.

12. A method as claimed in claim 11, in which, when the start-up blower system includes, in parallel, at least one blower and a start-up blower system in-line valve and connected in series with the blower a blower isolation valve, shutting down the start-up blower system includes opening the start-up blower system in-line valve, discontinuing operation of the blower and closing the blower isolation valve.

13. A nuclear power plant which includes
a closed loop power generation circuit; and
a start-up blower system which includes
a normally open in-line valve;
at least one blower connected in parallel with the in-line valve;
a normally closed blower isolation valve in series with the or each blower; and
a blower bypass arrangement in parallel with the or each blower.

14. A nuclear power plant as claimed in claim 13, which includes a closed loop power generation circuit including a nuclear reactor having an inlet and an outlet, a turbine arrangement, an upstream side of which is connected to the outlet of the reactor, a recuperator having a low pressure side and a high pressure side, each side of the recuperator having an inlet and an outlet, at least one compressor to which the turbine arrangement is drivingly connected and at least one heat exchanger, the closed loop power generation circuit being arranged to make use of a Brayton cycle as the thermodynamic conversion cycle, the plant further including a generator to which the turbine arrangement is drivingly connected and a variable resistor bank which is disconnectably connectable to the generator.

15. A nuclear power plant as claimed in claim 14, in which the power generation circuit includes a high pressure compressor and a low pressure compressor, the turbine arrangement including a high pressure turbine drivingly connected to the high pressure compressor, a low pressure turbine drivingly connected to the low pressure compressor and a power turbine drivingly connected to the generator.

16. A nuclear power plant as claimed in claim 15, in which the power generation circuit includes a pre-cooler connected between an outlet of the low pressure side of the recuperator and an inlet of the low pressure compressor and an inter-cooler connected between an outlet of the low pressure compressor and an inlet of the high pressure compressor.

17. A nuclear power plant as claimed in claim 16, in which the start-up blower system is positioned between the low pressure side of the recuperator and the pre-cooler.

18. A nuclear power plant as claimed in claim 16 or claim 17, in which the power generation circuit includes a low pressure compressor recirculation line in which a low pressure recirculation valve is mounted, the low pressure recirculation line extending from a position between the downstream side of the low pressure compressor and the inlet of the inter-cooler to a position between the start-up blower system and the inlet of the pre-cooler.

19. A nuclear power plant as claimed in any one of claims 16 to 18, inclusive, in which the power generation circuit includes a high pressure compressor recirculation line in which a high pressure compressor recirculation valve is mounted, the line extending from a position between the downstream side of the high pressure compressor and the inlet of the high pressure side of the recuperator to a position between the outlet of the low pressure compressor and the inlet of the intercooler.

20. A nuclear power plant as claimed in any one of claims 16 to 19, inclusive, in which the power generation circuit includes a recuperator bypass line in which a recuperator bypass valve is mounted, the recuperator bypass line extending from a position upstream of the inlet of the high pressure side of the recuperator to a position downstream of the outlet of the high pressure side of the recuperator.

21. A nuclear power plant as claimed in any one of claims 16 to 20, inclusive, in which the power generation circuit includes a high pressure coolant valve and a low pressure coolant valve, the high pressure coolant valve being configured, when open, to provide a bypass of helium from the high pressure side of the high pressure compressor to the inlet of the low pressure turbine and the low pressure coolant valve being configured to provide a bypass of helium from the high pressure side of the high pressure compressor to the inlet of the power turbine.

22. A nuclear power plant as claimed in any one of claims 13 to 21, inclusive, in which the reactor is of the pebble bed type.

23. A nuclear power plant as claimed in any one of claims 13 to 22 inclusive, in which the start-up blower system includes two blowers which are connected in parallel with a start-up blower in-line valve and a blower isolation valve which is associated with each blower.

24. A method as claimed in claim 1 substantially as described and illustrated herein.

25. A nuclear power plant as claimed in claim 13 substantially as described and illustrated herein.

26. A new method or plant substantially as described herein.
